(19) United States
(12) Patent Application Publication
(10) Pub. No.: US 2026/0336300 A1
(43) Pub. Date: Oct. 29, 2026

(54) INK TANK

(71) Applicant: Linx Printing Technologies Limited, St Ives (GB)

(72) Inventor: Stephen Eric Baldwin, St Ives (GB)

(21) Appl. No.: 19/113,496

(22) PCT Filed: Sep. 19, 2023
(86) PCT No.: PCT/GB2023/052418

§ 371 Date: Mar. 20, 2025

(30) Foreign Application Priority Data
Sep. 20, 2022 (GB) 2213742.6

(51) Int. Cl. B41J 2/175; B41J 2/08; B41J 2/185; B41J 2/20

(52) U.S. Cl. CPC B41J 2/17513; B41J 2/08; B41J 2/17566; B41J 2/17596; B41J 2/185; B41J 2/20; B41J 2002/17576; B41J 2002/1853

(57) ABSTRACT

An ink tank for an inkjet printer. The ink tank comprising a tank floor defining a bottom surface of the tank and tank walls defining sides of the tank during normal use. The tank comprising: a tank bottom defining a lowest point within the tank; a bulk region configured to store a majority of the ink within the ink tank, the tank floor within the bulk region being horizontal or sloping towards the tank bottom during normal use; and a mixing region between the tank bottom and the bulk region partially enclosed by a mixing region tank wall.

The present invention relates to inkjet printing and more particularly to an ink storage tank and mixing system for storing and mixing ink. The ink may be pigmented ink for use with an inkjet printer, such as a continuous inkjet printer.

In inkjet printing systems the print is made up of individual droplets of ink generated at a nozzle and propelled towards a substrate. There are two principal systems: drop on demand where ink droplets for printing are generated as and when required; and continuous inkjet printing in which the droplets are continuously produced and only selected ones are directed towards the substrate, the others being recirculated to an ink supply.

Continuous inkjet printers supply pressurised ink to a print head drop generator where a continuous jet or stream of ink emanating from a nozzle is stimulated to form individual regular drops by, for example, an oscillating piezoelectric element. The drops are directed past a charge electrode where they are selectively and separately given a predetermined charge before passing through a transverse electric field, which may be provided across a pair of deflection plates. Each charged drop is deflected by the field by an amount that is dependent on its charge magnitude before impinging on the substrate whereas the uncharged drops proceed without deflection and are collected at a gutter from where they are recirculated to the ink supply for reuse. The charged drops bypass the gutter and hit the substrate at a position determined by the charge on the drop and the position of the substrate relative to the print head. Typically, the substrate is moved relative to the print head in one direction and the drops are deflected in a direction generally perpendicular thereto, although the deflection plates may be oriented at an inclination to the perpendicular to compensate for the speed of the substrate (the movement of the substrate relative to the print head between drops arriving means that a line of drops would otherwise not quite extend perpendicularly to the direction of movement of the substrate).

In continuous inkjet printing a character may be printed from a matrix comprising a regular array of potential drop positions. Each matrix comprises a plurality of columns (strokes), each being defined by a line comprising a plurality of potential drop positions (e.g. seven) determined by the charge applied to the drops, and various other influencing factors. Thus each usable drop is charged according to its intended position in the stroke. If a particular drop is not to be used then the drop is not charged and it is captured at the gutter for recirculation. This cycle repeats for all strokes in a matrix and then starts again for the next character matrix.

Ink is delivered under pressure to the print head by an ink supply system that is generally housed within a sealed compartment of a cabinet that includes a separate compartment for control circuitry and a user interface panel. The system includes a main pump that draws the ink from a ink storage tank of the ink supply system via a filter and delivers it under pressure to the print head. As ink is consumed the tank is refilled as necessary from a replaceable ink cartridge that is releasably connected to the tank by a supply conduit. The ink is fed from the tank via a flexible delivery conduit to the print head. The unused ink drops captured by the gutter are recirculated to the tank via a return conduit by a pump. The flow of ink in each of the conduits is generally controlled by solenoid valves and/or other like components.

Reliable droplet generation (by jet break-up) is contingent on the ink having substantially inviscid properties, so ink in the ink tank is preferably dilute. Ink recirculating from the gutter is solvent-depleted due to evaporation of solvent. Therefore, the ink (storage) tank has its mixture continually adjusted with make-up solvent from a replaceable solvent cartridge to ensure that the ink being drawn from the ink tank has an acceptable viscosity.

Various types of inks maybe used within the continuous inkjet printers. The ink may include an organic solvent selected from C₁-C₄ alcohols, C₄-C₈ ethers, C₃-C₆ ketones, C₃-C₆ esters, and mixtures thereof. Inks may contain different types of colourant. In some circumstances dye based inks are used. This may typically be the case where the substrate onto which printing is performed is relatively light in colour such that light reflected from the surface on which printing is to be performed is coloured by the dye contained within the ink resulting in a pattern visible to the user. On the other hand, where a surface on which printing is conducted is dark in colour, and therefore does not reflect much light, pigmented inks maybe preferred. In such circumstances, the pigment contained within the ink may reflect certain colours of light, thereby ensuring that the printed image can be seen by a user. Of course, dye based, and pigmented inks may both be used for printing on some substrates, while pigmented inks may be used on light surfaces and, dye-based inks may be used on dark surfaces. One particular subgroup of pigmented inks is known as the hard pigmented inks. The pigment in these inks is typically a fine particulate of high hardness such as titanium dioxide, resulting in printed marks of high opacity.

Where pigmented inks are used, the ink consists of a suspension of colourant (i.e. pigment) particles within a solvent. Various other components or additives (e.g. surfactants or dispersants) may also be included within the composition of the ink. The ink composition may vary depending upon various characteristics, such as the colour required, the surface onto which printing is to be performed, solvents which are suitable for a particular application environment, and many other factors.

In operation, the contents of the ink tank are subjected to a degree of agitation by the operation of the ink supply system and return flow from the gutter. This means that pigment particles remain in a relatively uniform suspension.

Typically, continuous inkjet printers are operated continuously, but during events such as weekends and holidays it is desirable to shut the printer down. This is partially due to safety concerns as a continuous inkjet printer combines highly flammable liquids with high voltage power connections and also because continuous running reduces the lifespan of pumps. Therefore, it is inadvisable to leave continuous inkjet printers running unattended.

It will be understood however, that during such periods of printer inactivity, pigment (especially hard pigment) particles can settle within the ink tank under gravity, forming a layer of sediment at the bottom surface of the tank. Sedimentation may also from on other components of a printer or ink supply system, for example in filters for filtering ink and in ink supply lines. Sedimentation is accelerated in the ink tank, due to the substantially inviscid mixture providing little resistance to pigment settling. The sediment layer may be characterised by a dense, compacted layer of pigment with semisolid properties which may cause blockages of ink supply pathways if it were to enter into the internal fluid circuits of the printer.

It is an object of the present invention, among others, to provide an improved ink tank for use with an inkjet printer (such as a continuous inkjet printer) which solves one or more problems, whether identified above or otherwise of using pigmented inks, inks containing precipitates and/or solid deposits.

According to a first aspect disclosed herein there is provided an ink tank for an inkjet printer comprising a tank floor defining a bottom surface of the tank and tank walls defining sides of the tank during normal use, the tank comprising: a tank bottom defining a lowest point within the tank; a bulk region configured to store a majority of the ink within the ink tank, the tank floor within the bulk region being horizontal or sloping towards the tank bottom during normal use; and a mixing region between the tank bottom and the bulk region partially enclosed by a mixing region tank wall.

By providing a mixing region between the bulk region and the tank bottom (i.e. a tank global minima), gradual movement of ink sediment across the base of the bulk region can be promoted, preventing sediment compression. On the other hand, in the mixing region, a mixing element or other mixing device can be provided, which can disperse any compressed sediment. In this way, sediment compression in one small region can be managed more easily than sediment being distributed over a larger area. Further, by providing a larger bulk region with a less steeply sloping floor, it is possible to increase the volume of the tank for a given overall height, since less of the floor is steeply sloping than would be the case in a conventional conical tank.

The tank further comprises a tank roof defining a top wall of the tank. Together, the tank floor, tank walls and tank roof enclose the internal volume of the tank.

In the mixing region, the tank wall may also act as the tank floor in parts. That is, in at least some parts of the mixing region the sloping walls may act to define both a lower surface and a side surface of the tank. In other parts of the mixing region, the lower surface is provided by the tank bottom.

The terms “wall” and “floor” are used herein to refer to different portions of a tank wall that may be a continuous structure (e.g. formed as a single component). In general, where the gradient of the component is <45 degrees from horizontal, the region will be referred to as a “floor”, whereas where the gradient of the component is >45 degrees from horizontal, the region will be referred to as a “wall”.

The mixing region may have a circular cross-section when viewed from above.

In some examples, the join between the mixing region and the bulk region may be considered to be the point at which the tank walls transition to being a tank floor. That is, the point at which the angle of slope of the wall/floor becomes less than 45 degrees from horizontal.

Alternatively, the top of the mixing region may be determined based upon the width of the mixing region. For example, the top of the mixing region may be considered to be the point in the tank at which the tank width (or diameter) exceeds a predetermined value (e.g. 50 mm).

It will be appreciated, however, that it is possible to define the mixing region in numerous ways, and that the size and shape of the mixing region and bulk region may vary significantly. The advantages of providing a mixing region which has more steeply sloping side walls than the bulk region at a bottom of the tank may thus be achieved in a variety of ways.

The tank walls surrounding the mixing region between the tank bottom and the bulk region may be vertical or may have a steeper gradient than the tank floor in the bulk region.

By providing a mixing region with vertical, or more steeply sloping walls than the floor of the bulk region, it is possible to provide a convenient structural form, while also providing a desired floor and wall profile. That is, the less steeply sloping bulk region is separated from the tank bottom by the mixing region, which has steeper sides.

The tank walls surrounding the mixing region may be vertical, or may slope towards the tank bottom.

A gradient of the floor within the bulk region may be at least 2 degrees from a nominal horizontal baseline.

The gradient of the floor within the bulk region may be at least 5 degrees from a nominal horizontal baseline.

The gradient of the tank walls within the mixing region may be no greater than 85 degrees from a nominal horizontal baseline.

The nominal horizontal baseline may be defined as a line that is horizontal when the ink tank is orientated in a normal configuration for use, and when the ink tank is provided within a printer that is supported on a horizontal surface. Of course, it will be appreciated that in use the printer may be operated when supported on a surface that is not strictly horizontal, resulting in the nominal horizontal baseline deviating from the horizontal. Reference to the nominal horizontal baseline is intended to provide a convenient reference frame for other components of the printer, rather than limiting the orientation to strict compliance.

In view of the above, it will be appreciated that when describing the gradient of the tank walls within the mixing region as being no greater than 85 degrees from the nominal horizontal baseline, it is intended that, in use, the tank walls within the mixing region will be close to vertical (e.g. 85 degrees), but may vary from the use due to installation of the printer on a non-flat surface.

The tank may comprise a vertical depth of at least 15 mm from the tank bottom to a lowest part of the bulk region.

The ink tank may comprise a horizontal width of at least 18 mm at a vertical distance of 10 mm from the tank bottom.

The ink tank may comprise a horizontal width of no greater than 40 mm at a vertical distance of 10 mm from the tank bottom.

By providing a relatively narrow mixing region (e.g. less than 40 mm in width), it is possible to facilitate mixing, since a lower mixing power will be required to disperse any sediment that settles within the mixing region. On the other hand, if the mixing region is too narrow (e.g. less than 20 mm in width), it may need to be excessively tall in order to provide enough volume to accommodate a sufficient volume of pigment.

By defining the horizontal width at a distance of 10 mm from the tank bottom, it is intended to define a width of the mixing region.

The tank width in the bulk region may be significantly greater than the width in the mixing region. For example, the tank width in the bulk region may be approximately 100-200 mm.

The mixing region may have a volume of less than 5% of the total liquid volume of the tank.

The total liquid volume of the tank comprises the volume enclosed by the floor and walls of the tank below a maximum fill level (when in a normal operating orientation). It will, of course, be appreciated that it may be possible to over-fill the tank above this level, but nevertheless, in many tanks there exists a maximum or normal recommended fill level.

The ink tank may further comprise a transition region between the bulk region and the mixing region, wherein: the transition region may have a gradient greater than the bulk region floor gradient; and the transition region may have a gradient less than the mixing region wall gradient.

The transition region gradient need not be constant. That is, the transition may provide a gradual transition between the steeper sides of the mixing region and the flatter floor gradient of the bulk region.

In some examples, the transition region may comprise a more complex profile (e.g. such as an inflection point).

The addition of a transition region may allow higher viscosity ink forming in a settling region at the bottom of the bulk region floor to be delayed before reaching the mixing region.

The transition region may comprise a vertical depth of at least 15 mm from a highest part of the mixing region to a lowest point of the bulk region.

The transition region may comprise a vertical depth at least as deep as a vertical depth of the mixing region.

The transition region may have a volume of at least 5% of the total liquid volume of the tank.

The ink tank may further comprise a header region, wherein the header region may be provided above the bulk region of the tank, may be separated from tank floor by at least the bulk region, and may extend from a maximum liquid fill level of the tank to a tank roof.

The ink tank may further comprise a level sensor comprising a float and a float chamber, wherein: the float chamber may be in fluid connection with the mixing tank at least via an upper connection and a lower connection, the upper connection may be provided at or above a maximum liquid fill level of the tank, and the lower connection may be at or above an upper limit of the mixing region.

The lower connection may be provided within the transition region.

The level sensor may be configured to generate a low level signal when the liquid level in the tank is below a minimum fill level.

The level sensor may be configured to generate a high level signal when the liquid level in the tank is above a liquid maximum fill level.

The ink tank may further comprise a mixing arrangement provided within the mixing region; wherein the mixing arrangement may comprise a plurality of fluid ports each of the plurality of fluid ports comprising a respective aperture, the plurality of fluid ports may be configured to direct fluid away from the mixing arrangement and into the mixing region, towards the tank wall surrounding the mixing region.

The ink tank may further comprise a mixing arrangement provided within the mixing region; wherein the mixing arrangement may comprise a plurality of fluid ports each of the plurality of fluid ports comprising a respective aperture, the plurality of fluid ports may be configured to direct fluid away from the mixing arrangement and into the mixing region, towards the tank bottom.

The plurality of fluid ports may be configured to direct fluid away from the mixing arrangement and into the mixing region, towards the tank wall surrounding the mixing region and/or toward the tank bottom.

By providing the mixing arrangement within the mixing region, it is possible for sediment that has formed within the mixing region to be disturbed by jets of ink from the fluid ports.

According to a second aspect disclosed herein there is provided, an ink tank for an inkjet printer comprising a tank floor defining a bottom surface of the tank and tank walls defining sides of the tank during normal use, the tank comprising: a tank bottom defining a lowest point within the tank; a mixing arrangement provided proximate to the tank bottom, the mixing arrangement comprising a plurality of fluid ports each of the plurality of fluid ports comprising a respective aperture, the plurality of fluid ports being configured to direct fluid away from the mixing arrangement and into the region of the tank surrounding the mixing arrangement; and a fluid supply conduit configured to provide fluid to the plurality of fluid ports of the mixing arrangement, the fluid supply conduit being configured to deliver fluid to the mixing arrangement from below the mixing arrangement.

Arranging the fluid supply conduit to deliver fluid to the mixing arrangement from below the mixing arrangement reduces the risk of sediment forming within the fluid ports as a result of sedimentation within the supply conduit. Arranging the fluid supply in this way also avoids the need to provide a conduit within the upper (e.g. bulk) regions of the tank.

A mixing arrangement of this sort (i.e. supplied from below) can be combined with a tank having a mixing region (as described further above), or can be provided in a conventional tank (e.g. a tank having a conical, flat, or gradually sloping bottom).

The following optional features may be combined with either of the first or second aspects disclosed herein.

The plurality of fluid ports may be configured to direct fluid from the mixing arrangement in a plurality of directions and wherein: each of the plurality of directions may comprise a horizontal component and a vertically downwards component; and/or at least one of the plurality of directions may comprise a non-radial horizontal component.

The use of a non-radial horizontal component can cause fluid to flow around the mixing region in a circular manner, increasing the mixing performance.

The plurality of fluid ports may be configured to direct fluid radially outwards from the mixing arrangement.

The plurality of fluid ports may be configured to direct fluid towards a perimeter of the tank bottom.

By being directed towards the perimeter of the tank bottom, it is possible to maximise the mixing effect, since the fluid flow will be deflected by the tank floor and walls, and will then recirculate within the mixing region, disturbing settled pigment.

Each of the plurality of apertures may be oriented vertically, or at least partially downwards.

Each of the plurality of apertures may have a diameter of at least 1 mm.

Each of the plurality of apertures may have a diameter of less than or equal to 2 mm.

By arranging the apertures in this way, it is possible to reduce the likelihood of sediment falling into the apertures.

The plurality of ports may be tapered outwards towards the aperture, or straight.

The plurality of fluid ports may comprise at least 3 fluid ports.

The plurality of fluid ports may comprise no more than 10 fluid ports, preferably no more than 7 fluid ports.

By providing at least 3 fluid ports a wide area around the mixing arrangement can be mixed. By providing no more than 7 fluid points, a convenient minimum flow rate through each port can be maintained, thereby reducing the risk of blockage if a large number of ports is used.

Central axes of the plurality of fluid ports may be provided at a vertical separation distance of at least 3 mm from the tank bottom.

Each of the plurality of apertures may be provided at a horizontal separation distance of no greater than 15 mm from the tank wall.

By providing a relatively small horizontal distance, it is possible to provide effective mixing, even with a relatively low-power pump, since the ink ejected from the apertures is likely to reach the side walls.

Each of the plurality of apertures may be provided at a horizontal separation distance of at least 4 mm from the tank wall. If a horizontal separation distance is too small, a blockage may form, resulting in difficult mixing.

The tank may further comprise a mixing pickup configured to pickup ink fluid from the ink tank for mixing the ink. The mixing pickup may be provided within the bulk region.

By providing a supply of ink for mixing from within the bulk region, it is possible to reduce the likelihood of blockages occurring within the mixing assembly, since the bulk region is not likely to contain significant deposits of sediment.

The mixing pickup may also perform other functions. For example, the mixing pickup may also function as an ink return line (e.g. allowing ink to flow into the ink tank from the printhead gutter). Alternatively, the mixing pickup may comprise a separate mixing pickup port.

The tank may further comprise a fluid supply conduit configured to provide fluid to the plurality of fluid ports, the fluid supply conduit may be configured to deliver fluid to the mixing arrangement from below the mixing arrangement.

Arranging the fluid supply in this way reduces the risk of sediment forming within the fluid ports as a result of sedimentation within the supply conduit. Arranging the fluid supply in this way avoids the need to provide a conduit within the upper (e.g. bulk) regions of the tank.

The fluid supply conduit may comprise a vertical portion configured to deliver fluid to the mixing arrangement from below the mixing arrangement and a lateral portion configured to deliver fluid to the vertical portion, wherein the lateral portion may be sloped upwards away from the junction between the vertical portion and the lateral portion.

Providing a sloped supply conduit in this way reduces the risk of sedimentation within the supply conduit, since any sedimenting pigment will be caused to gradually move along the lower surface of the conduit, rather than solidifying along the bottom of the conduit.

The lateral portion may be sloped upwards away from the junction between the vertical portion and the lateral portion by an angle of at least 2 degrees to the horizontal.

The fluid supply conduit may further comprise a sump tank at the junction between the vertical portion and the lateral portion, the sump tank may be configured to receive sediment from the lateral portion.

When fluid is initially pumped along the lateral portion towards the mixing arrangement after a period of rest, sediment that has formed within the lateral portion can be driven towards the sump tank, reducing the risk that this sediment will block the fluid ports. The sump tank may have a volume of around 1 ml.

The tank may further comprise a fluid supply conduit configured to provide fluid to the plurality of fluid ports, the fluid supply conduit may be configured to deliver fluid to the mixing arrangement from above the mixing arrangement.

The fluid supply conduit may comprise a vertical portion directly above the mixing arrangement and a lateral portion configured to deliver fluid to the vertical portion, wherein the lateral portion may be sloped upwards away from the junction between the vertical portion and the lateral portion.

The fluid supply conduit above the mixing arrangement may comprise a vertical straight pipe.

The fluid supply conduit above the mixing arrangement may comprise a helically coiled pipe.

By providing a helically coiled pipe when delivering fluid from above the mixing arrangement, a gradual slope is introduced to the pipe, rather than a (predominantly) vertical orientation. This gradual slope causes any sediment to slowly move along the bottom of the pipe, and reduces the risk of sediment from blocking the fluid ports of the mixing arrangement.

According to a third aspect disclosed herein there is provided, an ink system comprising: an ink tank according to according to the first or second aspect; a mixing arrangement configured to mix ink within the mixing region.

The mixing arrangement may be a mechanical stirrer, or other form of agitation device.

The mixing arrangement may have a plurality of outlets. The mixing device may comprise a single port.

A pump may be provided to supply ink to the outlet or plurality of ports.

According to a fourth aspect disclosed herein there is provided, an ink system comprising: an ink tank according to the first or second aspect; and a pump configured to supply fluid to the mixing region.

The pump may be configured to supply ink to a plurality of outlets disposed within the mixing region.

According to a fifth aspect disclosed herein there is provided an ink system comprising: an ink tank according to the first or second aspect; and a pump configured to supply fluid to the mixing arrangement to mix ink.

The pump (in any of the third to fifth aspects) may be configured to pump ink from the ink tank via a mixing pickup and to supply the pumped ink to the mixing arrangement to mix ink.

The ink system (according to any of the third to fifth aspects) may be configured to drain ink into the ink tank during a shutdown operation; and the ink system may be configured to mix ink within the ink tank during a start-up operation. The ink system may be configured to mix ink within the ink tank during a period of idle operation.

Mixing ink may comprise causing ink to flow out of ports of a mixing device (e.g. a mixing arrangement) where present.

Draining ink may comprise allowing ink to flow into the tank under gravity and/or pumping ink into the tank.

According to a sixth aspect disclosed herein there is provided, a continuous inkjet printer comprising the ink system of any one of the third, fourth or fifth aspects, further comprising: a droplet generator configured to receive ink from the ink system and to produce a jet of ink for printing; a gutter configured to receive parts of the jet that are not required for printing; a gutter line connected to the gutter and configured to return unprinted ink to the ink tank.

The continuous inkjet printer may further comprise a printhead operable to receive ink from the ink system for printing, wherein the printhead comprises the droplet generator and the gutter.

The jet of ink may be a modulated jet of ink configured to form a stream of individual droplets.

The continuous inkjet printer may be an electrostatic deflection continuous inkjet printer configured to selectively charge ink droplets within the ink jet and to deflect charged droplets in an electrostatic field.

The droplets may be selectively, and in some cases variably, charged with the charging of each particular droplet being determined based upon a pattern to be printed.

The continuous inkjet printer may further comprise at least one charge electrode configured to induce charge on ink droplets, and at least one deflection electrode configured to generate the electrostatic field.

The printhead may comprise the charge electrode. The printhead may comprise the at least one deflection electrode. The printhead may comprise two deflection electrodes.

The continuous inkjet printer may be configured to cause charged droplets to be deflected by an amount in order to strike a substrate at a desired printing location to print a pattern to be printed.

The continuous inkjet printer may be configured to allow uncharged droplets to travel to the gutter. Unprinted ink droplets may be recirculated to the ink system.

The printer may comprise an ink supply line configured to transport ink from the ink tank to the droplet generator.

According to a seventh aspect disclosed herein there is provided a method of mixing pigmented ink comprising; storing ink in an ink tank, the ink tank comprising a tank floor defining a bottom surface of the tank and tank walls defining sides of the tank during normal use, wherein the tank comprises: a tank bottom defining a lowest point within the tank; a bulk region configured to store a majority of the ink within the ink tank, the tank floor within the bulk region being horizontal or sloping towards the tank bottom; and a mixing region between the tank bottom and the bulk region partially enclosed by a mixing region tank wall; the method further comprising mixing the ink within the mixing region.

By providing a mixing region between the bulk region and the tank bottom (i.e. a tank global minima), gradual movement of ink sediment across the base of the bulk region can be promoted, preventing sediment compression. When mixing is performed, only the relatively small volume of the mixing region is required to be mixed. Such missing can disperse any compressed sediment. In this way, sediment compression in one small region can be managed more easily than sediment being distributed over a larger area. Further, by providing a larger bulk region with a less steeply sloping floor, it is possible to increase the volume of the tank for a given overall height, since less of the floor is steeply sloping than would be the case in a conventional conical tank.

The method may further comprise, supplying fluid to a mixing arrangement provided within the mixing region, and directing the fluid away from the mixing arrangement and into the mixing region from a plurality of fluid ports, each of the plurality of fluid ports of the mixing arrangement comprising a respective aperture.

The tank may further comprise a mixing arrangement provided within the mixing region.

The method may further comprise supplying fluid to the mixing arrangement.

The method may further comprise directing fluid away from the mixing arrangement and into the mixing region towards the mixing region tank wall and/or towards the tank bottom from a plurality of fluid ports to mix the ink, each of the plurality of fluid ports comprising a respective aperture.

According to an eighth aspect disclosed herein there is provided a method of mixing pigmented ink comprising; storing ink in an ink tank, the ink tank comprising a tank floor defining a bottom surface of the tank and tank walls defining sides of the tank during normal use, wherein the tank comprises a tank bottom defining a lowest point within the tank and a mixing arrangement provided proximate to the tank bottom; supplying, to the mixing arrangement via a fluid supply conduit, fluid from below the mixing arrangement; and directing fluid away from the mixing arrangement and into the region of the tank surrounding the mixing arrangement to mix from a plurality of fluid ports, each of the plurality of fluid ports comprising a respective aperture. The method may comprise directing fluid away from the mixing arrangement and into the region of the tank surrounding the mixing arrangement from a plurality of fluid ports to mix the ink, each of the plurality of fluid ports comprising a respective aperture.

The mixing arrangement may be provided within a mixing region of the tank.

It will be appreciated that features described in the context of one aspect may be combined with other aspects described herein. For example, features described above in the context of an ink tank may also be applied to continuous inkjet printer comprising such an ink tank, or to a method of operation of such an ink tank, or to a method of manufacture of an ink tank, or a kit of parts. In particular, it will be appreciated that features of the ink tank of the first aspect can be combined with features of the ink tank of the second aspect; features of the ink system of the fifth aspect can be combined with the ink system of third aspect and/or the fourth aspect; features of the continuous inkjet printer of the sixth aspect can be combined with the ink tank of the first or second aspect, the ink system of the third to fifth aspects and the methods of the seventh and eighth aspects; and features of the seventh and eighth aspects can be combined and combined with features of the first to sixth aspects; and features of the first to eighth aspects can be combined.

Embodiments of the invention will now be described, by way of example only, with reference to the accompanying drawings in which:

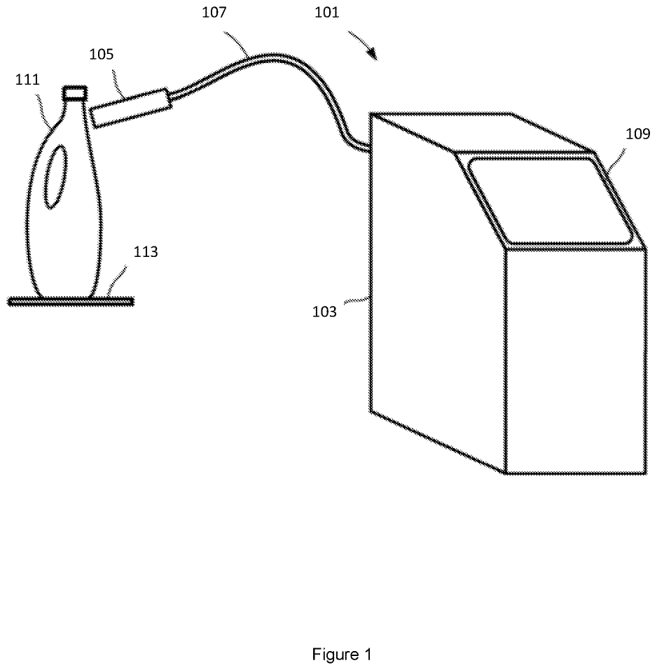

FIG. 1 schematically illustrates a continuous inkjet printer;

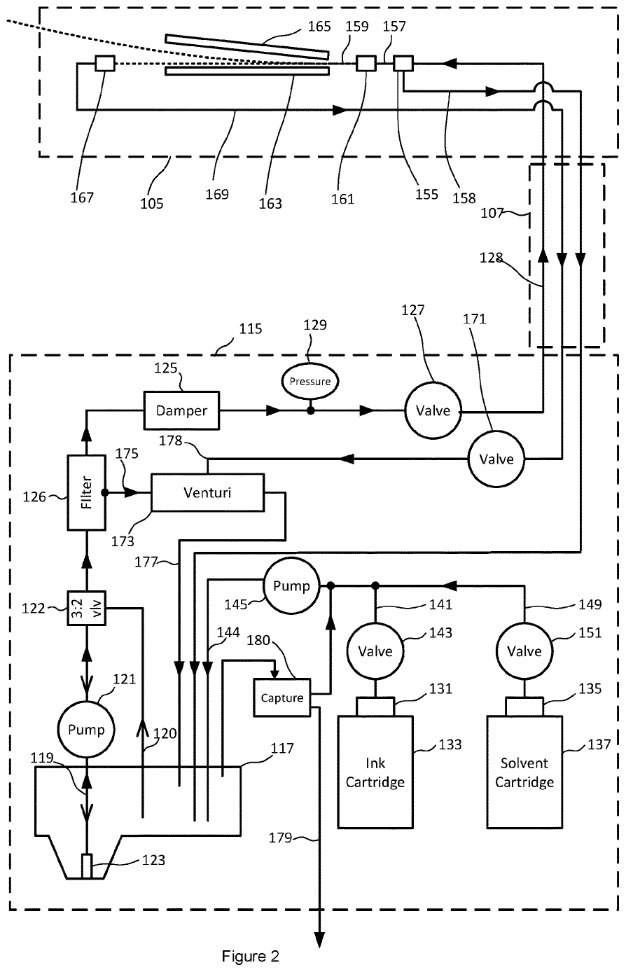

FIG. 2 schematically illustrates an ink circuit of the continuous inkjet printer shown in FIG. 1;

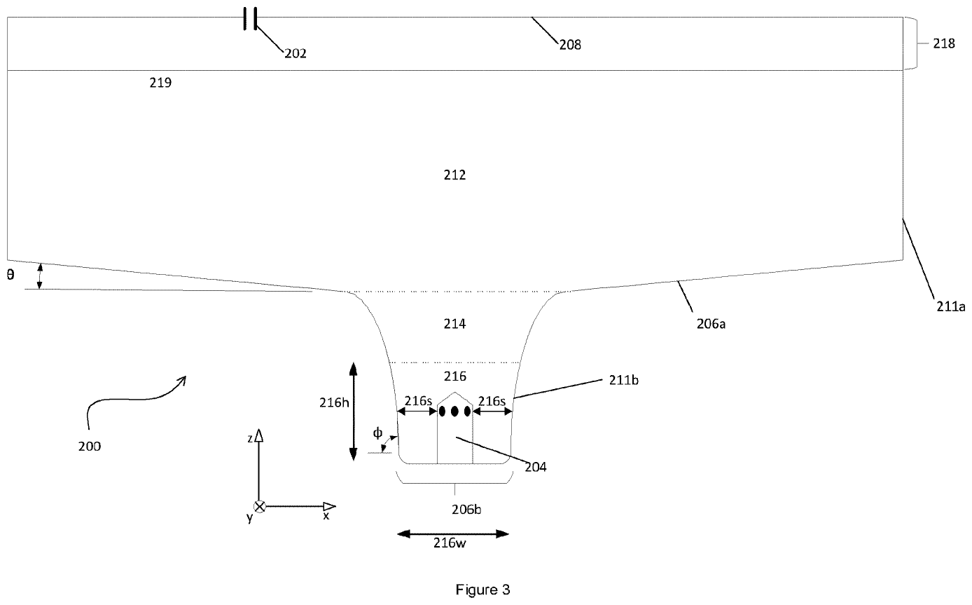

FIG. 3 schematically illustrates a cross section of an ink storage tank for use in the continuous inkjet printer shown in FIG. 1;

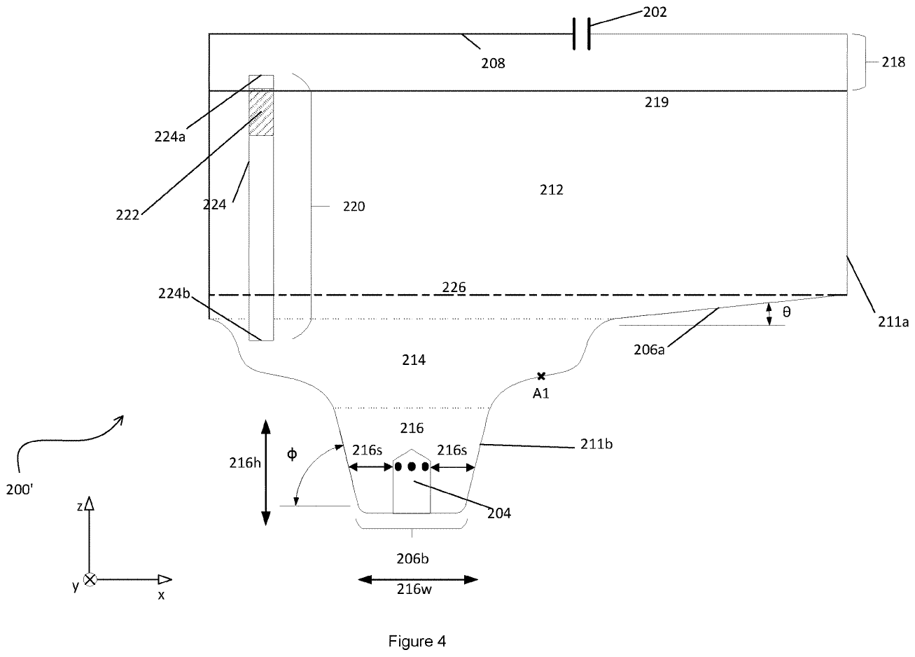

FIG. 4 schematically illustrates an alternative embodiment of an ink storage tank for use in the continuous inkjet printer shown in FIG. 1;

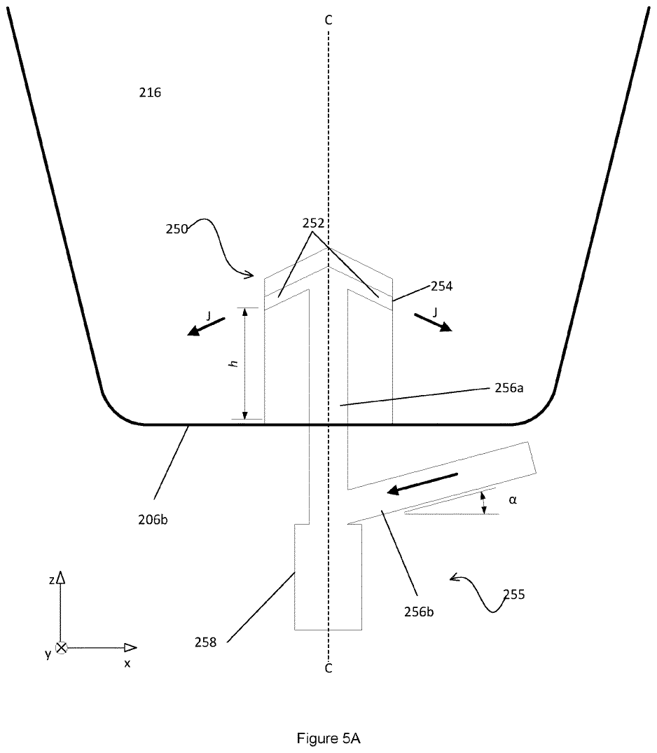

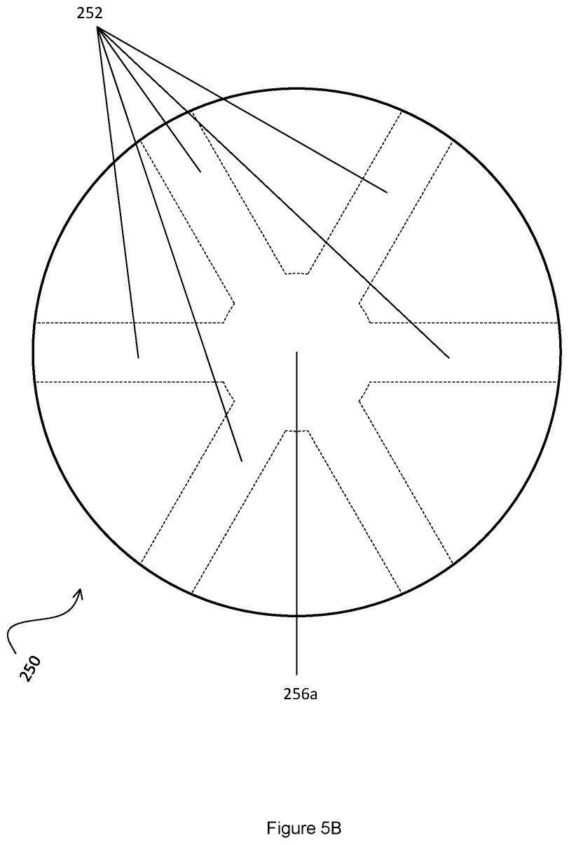

FIG. 5 schematically illustrates a mixing arrangement, having a bottom-mounted fluid supply conduit;

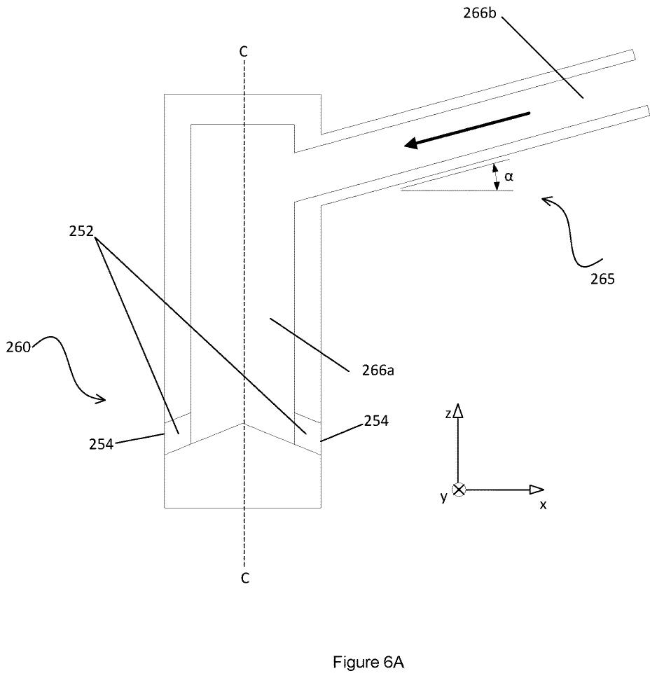

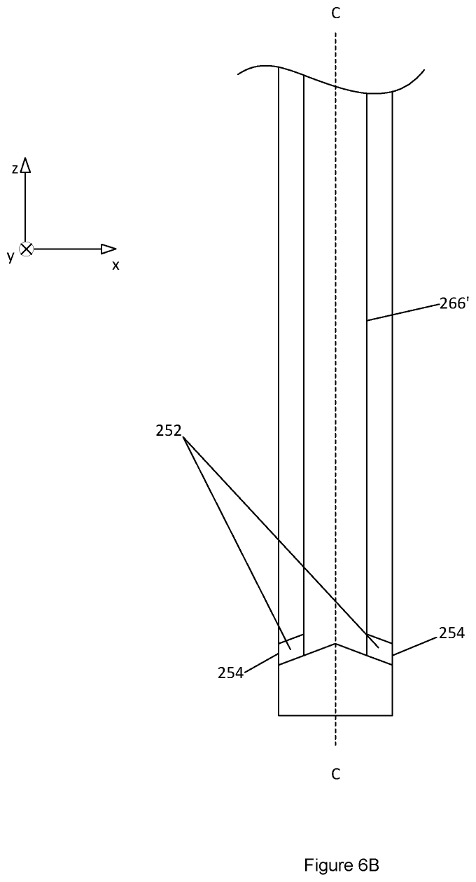

FIG. 6A schematically illustrates an alternative mixing arrangement, having a top-mounted fluid supply conduit, having a lateral section;

FIG. 6B schematically illustrates a further alternative mixing arrangement, having a top-mounted fluid supply conduit, without a lateral section; and

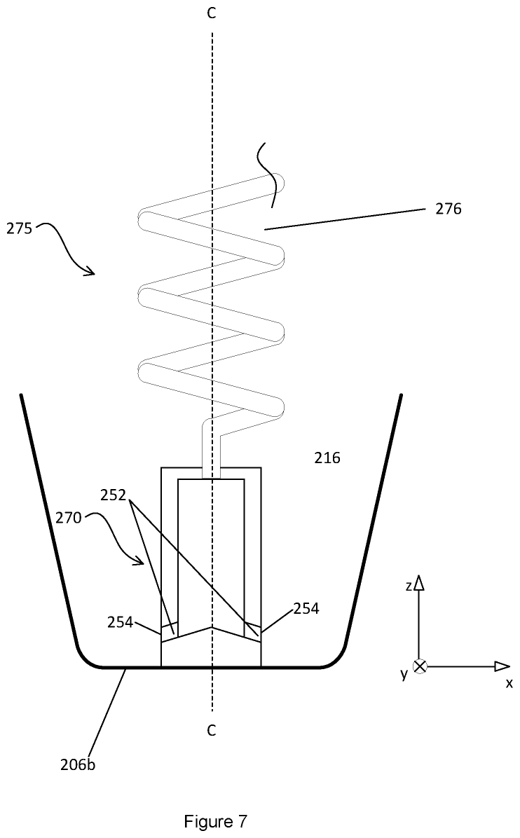

FIG. 7 schematically illustrates another alternative mixing arrangement, having a helical top-mounted fluid supply conduit.

In the figures, like parts are denoted by like reference numerals. It will be appreciated that the drawings are for illustration purposes only and may not be drawn to scale.

FIG. 1 schematically illustrates an inkjet printer 101. The printer 101 comprises a printer main body 103 connected to printhead 105 by an umbilical cable 107. The printer main body 103 may comprise the ink supply system and a printer controller, and the printer main body 103 may have a display 109 (e.g. a touchscreen) for use by an operator. The printhead 105 is arranged to print on a substrate, such as the surface of an item 111, moving along a production line 113.

Referring now to FIG. 2, a simplified schematic diagram of a possible fluid system for the ink jet printer of FIG. 1 is shown. The ink jet printer 101 comprises an ink supply system 115 which is contained within the main printer body 103. The ink supply system 115 comprises an ink tank 117 for storing ink. A mixing arrangement 123 is disposed below the fluid level of ink tank 117 and is connected to an ink pickup line 119. The ink pickup line is itself connected to a pump 121. Therefore, the fluid in the ink tank 117 is in fluid communication with the pump 121 with ink also passing through the mixing arrangement 123. The pump 121 has an outlet connected to a 3:2 valve 122. The 3:2 valve is operable to connect the pump 121 with a filter 126 to allow ink to be supplied from the ink tank 117 to a printhead 105 (as described in more detail below). The 3:2 valve also allows the pump to be connected to a mixing pickup 120, which is provided within the ink tank 117.

The pump 121 may be operated in a forward or reverse direction. When the pump 121 is operated in its forward direction, and the 3:2 valve 122 is configured to connect the pump outlet to the filter 126, the fluid system is referred to as being in a forward configuration. In the forward configuration, ink is drawn from the ink tank 117 via the mixing arrangement 123 and the ink pickup line 119 by the pump 121 towards the 3:2 valve 122. The pump drives the ink through the 3:2 valve 122 and then the filter 126. The filter 126 has an outlet connected to a damper 125.

The damper 125 is provided after the filter 126 to reduce fluctuations in ink pressure within the ink supply. A pressure sensor 129 is provided at the damper outlet and is configured to monitor the pressure at the outlet of the damper 125. A valve 127 is provided downstream of the pressure sensor 129. An ink supply line 128 is configured to carry ink from the ink supply system 15, along the umbilical 7, to the print head 5. The ink supply line 128 is connected to the ink pickup line 119 via the pump 121, 3:2 valve 122, filter 126, damper 125 and valve 127. Thus in the forward configuration, ink is drawn from the ink tank 117 toward print head 105. The valve 127 is configured to control the ink supply to the print head 105.

The ink supply system 115 also includes an ink cartridge connection 131 which may be connected to an associated ink cartridge 133 and a solvent cartridge connection 135 which may be connected to an associated solvent cartridge 137. The ink cartridge 133 and ink cartridge connection 131 are connected to an ink refill line 141, allowing ink to be drawn through a valve 143 by a pump 145 (e.g. a diaphragm pump), and fed to the ink tank 117.

Similarly, the solvent cartridge 137 and the solvent cartridge connection 135 are connected to a solvent refill line 149, allowing solvent to be fed via a valve 151 to the ink tank 117 under the suction of the pump 145. Each of the valves 143, 151 can be operated independently allowing either ink or solvent to be supplied to the ink feed tank independently of one another under the control of the pump 145.

In some configurations, an ink reservoir and/or a solvent reservoir (not shown) may be provided to temporarily store ink or solvent between the cartridge 133, 137 and respective refill line 141, 149.

In order to function properly, the ink supplied to the print head 115 must be within specified viscosity limits. The ink tank 117 acts as a premixed ink reservoir, such that any ink drawn from it conforms to viscosity specifications. The precise mix of ink and solvent is maintained by controlled admission of ink and solvent from the ink cartridge 133 and the solvent cartridge 137.

As described above, in use, ink is fed along the ink pickup line 119 and ink supply line 128 to the print head 105 via the umbilical 107. Within the print head 105 the ink is provided to a droplet generator 155. The ink is provided to the droplet generator under pressure (under the influence of the pump 121) and is forced through a nozzle of the droplet generator 155 forming an ink jet 157. The ink jet 157 begins as a constant stream of ink and, under the influence of surface tension and vibrations applied in the droplet generator 155 (e.g. by a piezoelectric oscillator), gradually separates into a series of ink droplets 159 which continue to travel in the direction of the ink jet 157.

In some printers (such as that illustrated in FIG. 2) a purge line 158 is connected to the droplet generator. The purge line 158 may be connected to a purge port of the droplet generator 155. The droplet generator 155 may be provided as part of a droplet generator assembly, which includes a droplet generator body having known acoustic properties, and a piezoelectric oscillator. The purge port may be provided by the body, or by a separate part connected to the body. The purge line 158 allows ink to flow out of the droplet generator via a purge aperture without passing through the nozzle, and allows the droplet generator to be cleaned. The purge line 158 extends from the droplet generator 155, along the umbilical 107, and returns ink (or solvent), depending upon the phase of operation, to the ink feed tank 117. One or more valves (not shown) may be provided within the purge line 158. It will be understood that the purge line is not essential, and may be omitted in some printers. Further, additional fluid lines may be provided in order to support some printer operations. For example, a solvent supply line may be provided in order to allow clean solvent to be supplied to the printhead for cleaning purposes.

Shortly after emerging from the nozzle of the droplet generator 155, the ink jet 157 is passed through a charge electrode 161. The point at which the continuous ink jet 157 separates into droplets 159 is arranged to occur within the charge electrode 161. The ink is an electrically conductive liquid, and the droplet generator is conventionally held at a fixed (e.g. ground) potential. A variable voltage is applied to the charge electrode 161 causing charge to be induced on the continuous stream of ink extending from the ink droplet generator 155 towards the charge electrode 161. As the continuous stream of ink (i.e. ink jet 157) separates into droplets 159, any charge induced on the ink within the droplet becomes trapped at the moment the individual droplet breaks off from the main stream of ink 157. In this way, a variable charge can be applied to each of the ink droplets within the stream of ink droplets 159.

The stream of ink droplets 159 then continues to pass from the charge electrode 161 and through an electrostatic field. In the illustrated example, the stream of ink droplets 159 passes between deflection electrodes 163, 165. A first one of the deflection electrodes 163 is held at a first voltage, whereas the second one of the deflection electrodes 165 is held at second voltage, with a large potential difference (e.g. 8-10 kilovolts) established between the deflection electrodes 163, 165. In some systems, one electrode may be maintained at a ground potential while the other electrode is held at a high (positive or negative) voltage (with respect to ground). In other systems, one electrode is held at a negative voltage (with respect to ground) and the other electrode is held at a positive voltage (with respect to ground). The field established between the deflection electrodes 163, 165 causes any charged droplets (i.e. those that have been charged by the charge electrode 161) to be deflected. In this way, based upon the variable charge applied by electrode 161, the droplets 159 can be selectively (and variably) steered from the path along which they are emitted from the nozzle of the droplet generator 155.

Droplets which pass through the deflection field without being deflected travel to a gutter 167. The gutter 167 comprises an orifice into which the droplets enter. The gutter 167 is connected to a gutter line 169 which extends from the gutter back to the ink supply system 115. A valve 171 is optionally provided within the gutter line 169 enabling the line to be opened and closed. Suction is applied to the gutter line 169 by a suction system so as to draw ink along the line from the gutter back towards the ink supply system 15.

The suction is provided in many inkjet printers by the suction system which comprises a Venturi 173 (which may also be referred to as a jet pump). The Venturi 173 is provided within the ink supply system 115 and is configured to receive a pressurised flow of ink from the ink pump 121 through a Venturi supply line 175, which is connected to a second outlet of the filter 126. The ink flowing through the Venturi 173 from the Venturi supply line 175 returns to the ink feed tank 117 via an ink return line 177 after it has passed through the Venturi 173.

The Venturi comprises a conduit with a converging then diverging cross section. The Venturi generates a localised region of high-speed, low-pressure flow by means of a constriction. The high-speed, low-pressure region is in communication with a suction port 178. In use, the gutter line 169 is connected, via the suction port 178 to the Venturi 173. In this way, the low pressure region created within the Venturi 173 is used to apply suction to the gutter line 169.

Any ink flowing into gutter 167 will be caused to flow along the gutter line 169, and will eventually be sucked into the Venturi 173 (via suction port 78) and will exit the Venturi and will pass along the return line 177 before returning to the ink feed tank 117.

By using a Venturi in this way (i.e. as a jet pump), a system can be designed in which the main system ink pump 121 can generate both positive pressures (e.g. to supply ink to the print head) and negative vacuum pressure (e.g. to provide gutter suction).

The ink tank 117 is vented by a vent 179, preventing excess pressure building up within the ink tank 117. It will be understood, however, that venting air via the vent 179 may cause solvent vapour to be vented to the external environment, which may be undesirable (e.g. since the solvent will need to be replaced, and may be damaging to the environment). In some embodiments, a capture system 180 may be connected to the vent 179 to capture solvent from the vented air. The capture system 180 may comprise a condenser. Captured solvent may be returned to another location within the ink supply system 115, such as, for example, the ink feed tank 117. The capture system 180 may be connected to the pump 145.

The filter 126 is described above as filtering ink for delivery to the printhead via ink supply line 128, and also for delivery to the Venturi 173 via Venturi supply line 175. It will be appreciated, however, that in alternative arrangements separate filters may be used. That is a first filter may be provided to fine filtering for the relatively small volume of ink supplied to the printhead, whereas a second filter may be provided to more coarsely filter the larger volume of ink supplied to the Venturi 173.

It will be understood that the ink cartridge 133 and the solvent cartridge 137 are replaced regularly (depending on ink and solvent use) in order to replenish the ink and solvent in the printer. In addition, other components of the printer 101 may be removable, in order to facilitate periodic cleaning, or replacement. For example, the ink tank 117 may be a removable module, so as to allow periodic replacement. The various fluid ports entering (and leaving) the ink tank 117 may thus be provided in one or more connection interfaces.

In the following discussion reference will be made to x, y and z axes: the reader's attention is drawn to the axes provided on FIGS. 3-7. It should also be noted that the z axis is consistently defined such that the (positive) z-axis is defined antiparallel to the direction of gravity, when the printer is in normal use.

Referring now to FIG. 3, an ink tank 200 is depicted in schematic cross-section, omitting connection ports apart from a vent 202 and mixing arrangement 204. The ink tank may comprise the ink 117 provided in printer 101. The ink tank 200 comprises a tank floor 206 defining a bottom surface of the tank, a tank roof 208, defining an upper surface of the tank, and tank walls 211 defining sides of the tank during normal use. The tank floor 206, tank roof 208 and tank walls 211 together define an internal volume which contains the ink.

The internal volume defined by the tank comprises a large bulk region 212, a transition region 214 and a relatively small mixing region 216. The disposition of the respective regions is indicated in FIG. 3. The bottom of the bulk region 212 adjoins the top of the transition region 214. The bottom of the transition region 214 adjoins the top of mixing region 216.

The tank floor 206 comprises a bulk region floor 206a (i.e. the tank floor adjacent to the bulk region 212) and a tank bottom 206b. The tank bottom 206b defines the lowest point within the tank and is adjacent to the bottom of mixing region 216.

The tank walls 211 comprise a bulk region wall 211a, and a mixing region wall 211b. The bulk region wall 211a, and mixing region wall 211b partially enclose the bulk region 4 and mixing region 6, respectively. It will be appreciated that although FIG. 3 shows a schematic cross-section of the ink tank, the tank walls 211 will define a three dimensional vessel for storing ink.

The bulk region 212 is configured to store a majority of the ink within the ink tank. The bulk region floor (i.e. the tank floor within the bulk region) 206a slopes with an angle θ≥0 towards the tank bottom 206b. In addition, the mixing region wall 211b is steeply sloped toward the tank bottom. Accordingly, the tank bottom 206b can be termed a minimum.

The transition region 214 is partially bounded by a section of the ink tank interior surface having a slope intermediate between the bulk region floor gradient and the mixing region wall gradient.

The mixing arrangement 204 is provided within the mixing region 216. In the depicted embodiment the mixing arrangement 204 is also connected to the tank bottom 206b. The mixing pickup 120 (see FIG. 2) may be provided within the ink tank 200 at a location within the bulk region 212. That is, it may be preferred for the mixing pickup to be provided at a location above the mixing region 216 and transition region 214 (where present).

In the illustration shown in FIG. 3, ink is stored within the ink tank and extends from the tank bottom 206b up to a maximum liquid fill level 219. The region of the ink tank internal volume between the maximum liquid fill level 219 and tank roof 208 may be referred to as a header region 218. The tank roof may further comprise a vent 202. The vent 202 puts the header region 218 in fluid communication with the external environment, allowing equalisation of pressure between the ink tank interior and the external environment. Such equalisation prevents the creation of pressure differentials such as elevated pressure within the header region 218 which could increase the demands on attached pumps in the fluid circuit. For example, the net inflow of gas into the ink tank 200 from a gutter line, would cause a build-up of pressure.

In the mixing region 216 and transition region 214, the tank wall may also act as the tank floor in parts. That is, in at least some parts of the mixing and transition region the sloping walls may act to define both a lower surface and a side surface of the tank. In other parts of the mixing region, the lower surface is provided by the tank bottom.

During periods of extended printer inactivity (e.g. long shutdowns), as described above, pigment particles within hard pigmented inks will begin to sink under gravity and settle. Thus, after an extended period, there will be a substantial positive concentration gradient of pigment particles in the negative Z-direction, as indicated in FIG. 3. A layer of compacted sediment with semi solid properties may form at the base of the tank.

However, in the presence of a minimum in the tank floor 206, and in the absence of any regions of positive gradient (i.e. sloping away from the minimum), particles adjacent to the tank floor do not sediment. Instead, particles adjacent to the floor undergo a biased random walk towards the local minimum by means of Brownian motion. This holds true even if there are areas in locality of the minimum that are perfectly horizontal.

By providing a more steeply sloping mixing region 216 between the bulk region 212 and the tank bottom 206b (i.e. a sole tank minimum), gradual movement of concentrated pigment particles across the floor 206a of the bulk region can be promoted, preventing sediment formation outside the tank bottom 206b. Hence, sedimentation is substantially localised in the smaller mixing region, limiting the sediment volume needing dispersal.

In the mixing region 216, a mixing arrangement, such as the mixing arrangement 204 or other mixing device, can be provided. The mixing arrangement can disperse any compressed sediment. In this way, sediment compression in one small region can be managed more easily than sediment being distributed over a larger volume. Further, by providing a larger bulk region with a less steeply sloping floor, it is possible to increase the volume of the tank for a given overall height, since less of the floor is steeply sloping than would be the case in a conventional conical tank

The transition region 214 may be omitted in some examples. In other examples, the transition region 214 may be considered to be part of more extensive mixing region. However, in the absence of a transition region, the pigment particles in the bulk region 212 would random walk directly into the mix region 216. This would may lead to increased sedimentation pressure in the mixing region 216, which may then accelerate sediment formation. With an appropriately sized transition region 214, pigment particles originating in the bulk region 212 are very unlikely to reach the mixing region 216 within the period of time for which the printer may customarily be left inactive. However, it will be appreciated that for shorter expected periods of inactivity, or with an appropriately sized bulk region and mixing region, a transition region may not be required.

On resumption of inkjet printer operation after a period of extended inactivity, any ink sediment present in the mixing region can be dispersed by means of the mixing arrangement 204. The mixing arrangement 204 is operable to eject fluid. One of the major parameters determining the effectiveness of mixing is the volumetric power input: smaller mixing region volumes require less power input (by agitation) in total for effective mixing than larger mixing region volumes. As such, the limited volume of sediment needing dispersal within the mixing region 216 results in less mixing power input being demanded of the mixing arrangement. Mixing power input in the case of agitation by fluid jet is generally proportional to flowrate. Hence, inexpensive lower flowrate pumps may be used, or higher flowrate pumps may be operated at a lower-flowrate, prolonging their lifespan. Further, the limited volume of sediment needing dispersal reduces the mixing time taken for a given mixing power input.

The structure and operation of the mixing arrangement 204 and its supporting structures will be discussed in more detail below.

FIG. 4 shows another embodiment of an ink tank. Ink tank 200′ is substantially similar to ink tank 200 described above with reference to FIG. 3. However, ink tank 200′ further comprises a level sensor 220. In addition, the tank floor geometry of ink tank 200′ differs from ink tank 200 in that it comprises an inflection point A1 in profile, and that the mixing region 216 and transition region 214 are off-centre with respect to the bulk region 212. The inflection point A1 is provided to increase the effective volume of the transition region 214. A further benefit is that the overall volume of the ink tank 200′ is increased relative to the height occupied by the ink tank.

The level sensor 220 comprises a (magnetic) float 222 and a float chamber 224. The float chamber is in fluid connection with the mixing tank at least via an upper connection 224a and a lower connection 224b. The upper connection is provided above the maximum liquid fill level of the tank 219. The lower connection is provided within the transition region 214. As long as the float is buoyant in the ink, the float moves with the ink level.

The float 222 may be magnetic and actuate an external Hall-effect sensor (not shown) providing an indication of its position, and therefore the level of the ink in the tank (illustrated as maximum liquid fill level 219).

In use, the level sensor 220 is configured to generate a low level signal when the liquid level in the tank is below a minimum fill level 226. The level sensor 220 is also configured to generate a high level signal when the liquid level in the tank is at or above a liquid maximum fill level 219.

In practice, the minimum fill level 226 will be significantly, for example 300%, higher than the point at which the printer stops functioning. This is preferred in order to provide ‘buffer’ time in which an operator can prepare and insert a new ink and or solvent cartridge on receipt of the low level signal as well as some additional margin of error. In addition, the float exhibits some degree of lag, or hysteresis, in its level indication, which demands additional allowance with respect to the minimum fill level 226. Whilst 300% of the level at which the printer failure occurs is given as an example this could vary between different printer systems and/or ink and solvent cartridges.

The upper connection may also be at the maximum liquid fill level 219. The lower connection may be situated at or above an upper limit of the mixing region. In the embodiment of FIG. 4, the lower connection 224b is situated in the transition region 214, this has the advantage of lowering the low position of the float relative to the rest of the ink storage tank.

Given that magnetic floats tend to have non-negligible dimensions and a high density, the float will be significantly submerged (‘sit low’) when in buoyant equilibrium. By providing the lower connection 224b in the transition region, sufficient fluid depth can be provided to allow the magnetic float 222 to float at the lowest level needing to be sensed. In order to accurately sense the liquid level, as described above, the magnetic float 222 needs to be in buoyant equilibrium—hence a lower connection position within a deeper section of the tank, such as the mixing or transition region, is advantageous for sensing very low ink levels.

One benefit of the off-centre mixing region 216 positioning is that it facilitates positioning of a float-based level sensor near a tank wall, such that the magnetic float 222 can better interact with an external Hall-effect device to indicate the ink level.

It will be appreciated that the level sensor has been described by way of example only and may configured differently, or even omitted entirely, in some embodiments.

It should be understood that in relation to FIGS. 3 and 4, the terms “wall” and “floor” are used herein to refer to different portions of a tank wall that may be a continuous structure (e.g. formed as a single component). In general, where the gradient of the component is <45 degrees from horizontal, the region will be referred to as a “floor”, whereas where the gradient of the component is >45 degrees from horizontal, the region will be referred to as a “wall”.

Given the significant similarities between the embodiments of FIGS. 3 and 4, their geometric particulars are discussed in common.

It will be appreciated, however, that certain features of the tank may be omitted. For example, in some examples a transition region 214 may be omitted, with the mixing region extending from the tank bottom to the bulk region. Similarly, the bulk region floor slope may be omitted such that the floor is horizontal (i.e. θ=0). Further, the tank roof 208 may be omitted. Further still, the mixing arrangement 204 may be omitted. As such, an embodiment having any combination of some, all or none of these features may be provided.

In practical use cases, the perfect alignment of the ink tank cannot be guaranteed, therefore the bulk region floor 206a may be sloped towards the global minimum, indicated by the angle θ in FIGS. 3 and 4. For example, the slope may be at least 2° from the nominal horizontal plane—the x-y plane in FIGS. 3 and 4. The sloping of the bulk region floor 206a creates some tolerance in tank orientation—in the case of a 2° slope, any accidental tilt of the ink tank between ±2° will not substantially affect the ink tank's function. At worst, a portion of the bulk region floor 206a will be horizontal, which still facilitates particle motion along the tank floor.

In practice, users may find orienting a printer system, containing an ink tank, horizontally within ±2 degrees difficult. Therefore, the bulk region floor 206a may have a slope greater than this amount. For example a slope of equal to or greater than 5 degrees may be preferred in some embodiments (e.g. 6 degrees), from the nominal horizontal plane.

The angular geometry of the tank walls 211 may also be varied according to use conditions. The tank walls surrounding the mixing region (i.e. the mixing region walls) 211b between the tank bottom 206b and the bulk region 212 may be vertical or have a steeper gradient than the tank floor in the bulk region 206a.

By providing a mixing region with vertical, or more steeply sloping walls 211b than the floor of the bulk region, it is possible to provide a convenient structural form, while also providing a desired floor and wall profile. That is, the less steeply sloping bulk region is separated from the tank bottom 206b by the mixing region 216, which has steeper sides.

The tank walls surrounding the mixing region 211b may be vertical, or may slope towards the tank bottom.

In addition, the angle of the tank walls within the mixing region, labelled φ in FIGS. 3 and 4 at any point may be restricted to 85 degrees from the nominal horizontal plane.

It should be understood that the term ‘nominal horizontal plane’ refers to a virtual plane defined in relation to the ink tank that should be perpendicular to the direction of gravity under the exact as-designed orientation. Of course, it will also be appreciated that in use the printer may be operated when supported on a surface that is not strictly horizontal, resulting in the nominal horizontal plane deviating from the horizontal. Reference to the nominal horizontal plane is intended to provide a convenient reference frame for other components of the printer, rather than limiting the orientation to strict compliance.

In view of the above, it will be appreciated that when describing the gradient of the tank walls within the mixing region as being no greater than 85 degrees from the nominal horizontal baseline, it is intended that, in use, the tank walls within the mixing region will be close to vertical (e.g. 85 degrees), but may vary from the use due to installation of the printer on a non-flat surface.

None of the figures presented are to scale: the exact geometry of the ink tank 1 may also vary according to the end-user's requirements such as space and capacity demands or properties of ink.

In an example, an ink tank may have a vertical depth 216h of at least 15 mm from the tank bottom 206b to a lowest part of the bulk region 212.

In some examples, the join between the mixing region 216 and the bulk region 212 (where a transition region is omitted) may be considered to be the point at which the tank walls transition to being a tank floor. That is, the point at which the angle of slope of the wall/floor becomes less than 45 degrees from horizontal.

Alternatively, the top of the mixing region 216 may be determined based upon the width of the mixing region 216. For example, the top of the mixing region 216 may be considered to be the point in the tank at which the tank width (or diameter) exceeds a predetermined value (e.g. 50 mm). It will be appreciated that the width of the mixing region may vary (e.g. gradually increase) from the tank bottom 206b towards the top of the mixing region.

It will be appreciated that it is possible to define the extent of the mixing region 216 in numerous ways, and that the size and shape of the mixing region 216 and bulk region 212 may vary significantly. The advantages of providing a mixing region 216 which has more steeply sloping side walls than the bulk region 212 at a bottom of the tank may thus be achieved in a variety of ways.

The mixing region width 216w (which may, for example, be defined as a horizontal width at a vertical distance of 10 mm from the tank bottom 206b) may also be controlled in order to facilitate enhanced mixing. In particular, by providing a relatively narrow mixing region (e.g. less than 40 mm in width), it is possible to facilitate better mixing, since a lower mixing power will be required to disperse any sediment that settles within the mixing region than for a comparably larger width. On the other hand, if the mixing region is too narrow (e.g. less than 18 mm in width), it may need to be excessively tall in order to provide enough volume to accommodate a sufficient volume of pigment.

Of course, it will be understood that the dimensions described here are based on the combination of a particular mixing arrangement 204 and mixing region 216. As such, a mixing arrangement 204 having a larger diameter may be used in combination with a mixing region 216 having a larger diameter, and vice versa.

The tank width in the bulk region 212 may be significantly greater than the width in the mixing region. For example, the tank width in the bulk region may be approximately 100-200 mm.

It should be appreciated that the vertical depth and horizontal width may be varied as dictated by the settling rate of a particular ink and the design requirements for maximum customary periods of inactivity.

In some systems, the maximum period a printer can be left inactive is around eight weeks. This is because in the case that a printer is inactive for longer than eight weeks, there is a high probability that other components in the printer will fail. For example, it may be known that some ink pumps are liable to seize if left inactive for more than eight weeks. With this in mind, an ink tank of such systems may be designed to accommodate 8 weeks of accumulated sediment. Of course, a system may be designed to accommodate longer periods of inactivity, but in some circumstances, any longer would be redundant in view of the other likely sources of failure.

In another example, the mixing region 216 may have a volume of less than 5% of the total liquid volume of the tank. This selection may be advantageous in that it limits the amount of compacted sediment in the mixing region. Any subsequent dispersing action has a lower mixing power input demand and/or will proceed more rapidly. Indeed, in some embodiments the mixing region volume may be significantly smaller than 5%. In addition, the provision of a small volume mixing region may increase the tank capacity relative to its total volume footprint.

On the other hand, the provision of a larger volume mixing region 216 would extend the time in which the sediment would be contained in the mixing region only—i.e. the period of time for which the printer may customarily be left inactive.

It should be understood that the total liquid volume of the tank comprises the volume enclosed by the floor 206 and walls 211 of the tank below the maximum fill level 219 (when in a normal operating orientation). It will, of course, be appreciated that it may be possible to over-fill the tank above this level, but nevertheless, in many tanks there exists a maximum or normal recommended fill level.

The volume of the header region 218 is provided to contain froth created by air induction from the gutter (cf. ink return line 177 in FIG. 2). The volume of the header region 218 may, for example, be at least equal to the volumetric air induction of the attached inkjet printer over one minute. In an example this may be around 180 ml, in the case of an inkjet printer with a maximum expected air intake volumetric rate of 180 ml/minute. Of course, the rate of froth generation, and decay, will vary between different ink supply systems, and different inks. As such, the volume of the header region 218 may vary according to particular application requirements.

Another geometric parameter of the mixing tank is its x-y, or sectional geometry.

FIGS. 3 and 4 are x-z plane cross-sectional views. The ink tank may be any one of a number of x-y plane section geometries. For example, the x-y plane sectional geometry of the mixing region 216 may be circular, polygonal or ovoid.

As described above, the height and volume of the mixing region 216 may be determined according to a specified height or percentage volume relative to the total ink tank volume. Preferably, the average x-y plane cross section of the mixing region 216 may also be restricted, such that the apertures are provided at a horizontal separation distance 216s from the mixing region tank wall 211b. The horizontal separation distance 216s may be no greater than a specified distance, for example 15 mm. Advantageously, such a geometric restriction promotes effective mixing, as mixing jets dissipate (in energy and hence dispersive effectiveness) over longer length scales. By limiting the distance at which sediment forms from the mixing arrangement, effective dispersal can be ensured for a given pump. As such, the specified maximum separation between the mixing region tank wall 211b and ports of the mixing arrangement 204 will be determined by the characteristics of a particular system—e.g. the ink properties, fluid flowrate from the mixing arrangement, the geometry of the tank and mixing arrangement.

A lower limit may also be applied in some circumstances, so as to reduce the likelihood of blockages forming. For example, the horizontal separation distance 216s may be at least 4 mm.

In a particular example, the mixing arrangement has a width of around 15 mm, with the mixing region 216 having a width of about 27 mm at a vertical height adjacent to the ports (e.g. 3 mm from the tank bottom), allowing a separation distance of around 6 mm to be provided between each side of the mixing arrangement 204 and the mixing region tank wall 211b.

In FIG. 3 the mixing region is depicted centrally, but the mixing region could also be positioned off-centre as described with reference to FIG. 4, or immediately adjacent to a tank wall (e.g. such that some part of the mixing region wall 211b is contiguous with part of the bulk region wall 211a), among other options. An advantage of placing the mixing region wall 211a adjacent to the bulk region wall 211b is that it allows the placement of a magnetic float level sensor (e.g. 220 of FIG. 4) within the deeper transition 214 or mixing regions 216 of the ink tank. However, a centrally-placed mixing region may increase the fluid volume of the ink tank relative to its total footprint.

The exact x-y plane geometry could be varied according to use-case and particularly spatial compatibility with surrounding equipment within the inkjet printer.

The transition region 214 sizing and geometry may also be adjusted to better fit the application's demands. For example, the transition region 214 may comprise a vertical depth at least as deep as a vertical depth of the mixing region 216. In this way, pigment in the bulk region 212 will fall into the transition region and the time elapsed in settling through the depth of the transition region will match or exceed the specified maximum period of inactivity. Consequently, pigment particles in the bulk region 212 of a device configured as described here will not reach the mixing region 216 in the specified maximum period of inactivity.

For example, the transition region 214 may comprise a vertical depth of at least 15 mm from a highest part of the mixing region 216 to a lowest point of the bulk region 212.

The volume of the transition region 214 may be specified to complement the properties of the ink to be contained in the ink tank. In an embodiment it may be advantageous to have a transition region capable of containing the all the pigment contained in the ink tank. This is advantageous because it ensures that pigment does not concentrate to solid densities, causing sedimentation at the base of transition 214 or even bulk region 212.

For example, if the volumetric proportion of pigment in an ink were 5%, then the transition region 214 may have a volume of at least 5% of the total liquid volume of the tank.

The transition region 214, where present, may have a variety of profiles, the selection of which would be optimised according to the above-described constraints and/or any spatial considerations imposed by inkjet components surrounding the ink tank.

The ink tanks described with reference to FIGS. 3 and 4 are provided with a mixing arrangement 204, provided within the mixing region 216. The mixing arrangement 204 may be secured by means of fasteners, welding or an interference fit of cooperating mechanical features. The mixing arrangement 204 may be connected to a pump in the fluid supply system via a fluid delivery circuit. The fluid delivery circuit may for example be synonymous with the ink pickup line 19 described with reference to FIG. 2. It will be understood, however that the mixing arrangement of the sort described can be omitted entirely, and that an alternative mixing arrangement may be provided. Examples of other mixing arrangements may include a mechanical stirrer, other form of agitation device, or a single fluid port. A further alternative may include a plurality of fluid ports provided within the tank walls, and disposed around the perimeter of the mixing region.

The combination of the mixing arrangement and the associated fluid delivery circuit may be referred to as the mixing assembly.

An example of a possible mixing assembly is illustrated in axial cross-section in FIG. 5A. The mixing arrangement 250 is shown in-situ in the mixing region 216, connected to the tank bottom 206b. The mixing arrangement comprises a plurality of fluid ports 252 each comprising an aperture 254. In the illustrated embodiment, the bottom edge of the apertures being are provided at a separation distance h from the tank bottom 206b. The fluid ports 252 are configured to direct fluid away from the mixing arrangement (as a jet) and into the mixing region 216 in a plurality of directions, or jet vectors J. The fluid ports 252 may be configured to direct fluid away from the mixing arrangement towards the tank wall 211b surrounding the mixing region 216 and/or towards the tank bottom 206b.

Each jet vector J comprises a horizontal (x, y) component and a vertically downward (negative z) component. The plurality of fluid ports is configured to direct fluid towards a perimeter of the tank bottom 206b. The perimeter of the tank bottom 206b is defined by the junction between the mixing region wall 211b and the tank bottom 206b.

The direction of fluid flow in operation is indicated by arrows provided in FIG. 5.

The mixing arrangement 250 of FIG. 5A is also shown in radial cross section in FIG. 5B. The dashed lines indicate the horizontal (x-y) profile of the fluid supply conduit 256a and fluid ports 252. Because the fluid ports 252 are arranged radially in the horizontal plane, the resulting jet vectors J have a substantially radial horizontal component.

The fluid delivery circuit 255 comprises a fluid supply conduit 25 configured to provide fluid to the plurality of fluid ports 252 of the mixing arrangement, the fluid supply conduit 256 being configured to deliver fluid to the mixing arrangement from below the mixing arrangement 250. Arranging the fluid supply in this way avoids the risk of sediment forming within the fluid ports 252 as a result of sedimentation within the supply conduit 256. Arranging the fluid supply in this way also avoids the need to provide a conduit within the upper (e.g. bulk) regions of the tank.

The fluid supply conduit 256 comprises a vertical portion 256a configured to deliver fluid to the mixing arrangement from below the mixing arrangement and a lateral portion 256b configured to deliver fluid to the vertical portion. The lateral portion 256b is preferably sloped upwards away from the junction between the vertical portion and the lateral portion. The fluid supply circuit further comprises a sump tank 258 at the junction between the vertical portion 256a and the lateral portion 256b.

Providing a sloped supply conduit in this way reduces the risk of sedimentation within the supply conduit. The slope, labelled α, induces sedimenting pigment to gradually move along the lower surface of the conduit, rather than solidifying along the bottom of the conduit. The sedimenting pigment is received in the sump tank 258. As a result, subsequent flows can bypass any sediment in the fluid delivery system.

The sump tank 258 may be sized such that it can contain all the sediment expected to accumulate between maintenance cycles, when it is replaced. In an example, the sump tank 258 may have a capacity of roughly 1 ml. Advantageously, this means that the mixing assembly does not require periodic cleaning.

In an example, the lateral portion 256b may be sloped upwards away from the junction between the vertical portion 256a and the lateral portion 256b by an angle of at least 2 degrees to the horizontal. Advantageously, this means that the lateral portion 256b will have some degree of slope towards the sump tank 258, even in situations where the printer is not orientated perfectly horizontally.

When fluid is initially pumped along the lateral portion 256b towards the mixing arrangement after a period of rest, sediment that has formed within the lateral portion can be driven towards the sump tank, reducing the risk that this sediment will block the fluid ports 252.

In use, fluid is pumped through the fluid delivery circuit 255 and out of the fluid ports 252, forming a plurality of jets directed towards the mixing region walls and tank bottom. The erosive action of each jet bores channels through the sediment and sediment is entrained and/or collapses into the moving fluid jet, achieving thorough mixing at a moderate flowrate.

Other layouts are possible for the fluid delivery circuit of the mixing arrangement.

FIG. 6A illustrates an alternative mixing arrangement 260. A fluid delivery circuit 265 is provided, comprising a fluid supply conduit 266 configured to provide fluid to the plurality of fluid ports 252, each port defining an aperture 254. The fluid supply conduit 266 is configured to deliver fluid to the mixing arrangement from above the mixing arrangement. The fluid supply conduit comprises a vertical portion 266a directly above the mixing arrangement and a lateral portion 266b configured to deliver fluid to the vertical portion 266a, wherein the lateral portion 266b is sloped upwards away from the junction between the vertical portion 266a and the lateral portion 266b.

It will be appreciated that the lateral portion 266b of the fluid supply conduit is optional, and that the fluid supply conduit could be entirely vertical. Such an alternative configuration is illustrated in FIG. 6B. The fluid supply conduit is a straight, purely vertical channel member 266′.

FIG. 7 depicts another alternative mixing assembly comprising mixing arrangement 270 and fluid delivery circuit 275, comprising a fluid supply conduit 276 above the mixing arrangement, itself comprising a helically coiled pipe. Fluid supply conduit 276 is configured to provide fluid to the plurality of fluid ports 252, each port defining an aperture 254.

It should be appreciated that a straight vertical pipe could also be used in place of the helical pipe 276 (as shown in FIG. 6B). Disadvantageously, this subjects the internal space (i.e. of the fluid supply conduit and fluid ports) to direct sedimentation pressure, increasing the risk of blockage.

By providing a helically coiled pipe 276 when delivering fluid from above the mixing arrangement, a gradual slope is introduced to the pipe, rather than a (predominantly) vertical orientation. This gradual slope causes any sediment to slowly move along the bottom of the pipe, and reduces the rate at which sediment reaches the fluid ports 252. Hence, the risk of sediment blocking the fluid ports of the mixing arrangement is greatly reduced. Alternatively, or additionally, the time taken before blockage by sediment will occur is greatly increased.

Feeding from above as shown in FIGS. 6A, 6B, or 7 may be advantageous in cases where height constraints are present. Feeding from below as described with reference to FIG. 5 increases the total height of the tank due to the sump tank and other fluid delivery components provided below the bottom of the tank.

The jet-producing portions of the mixing arrangements described with reference to FIGS. 5A, 5B, 6A, 6B and 7 are substantially similar, so their geometric particulars are discussed in common.

In some embodiments the horizontal component of the fluid port direction may be purely radial, as shown in relation to FIG. 5B.

In other embodiments, the fluid ports 252 may also be provided with a non-radial horizontal component, relative to vertical centre axis C-C. The use of a non-radial horizontal component can induce circulating flows in the mixing region, increasing the mixing performance.

Depending on the intended application and the properties of the operating environment, the size and orientation of the fluid port apertures 254 may be varied.

For example, each of the plurality of apertures 254 may be oriented vertically, or at least partially downwards. That is to say, that the normal direction of the planes defined by the plurality of apertures 254 may have a horizontal or partially vertical (and facing downwards) direction. Such an arrangement is advantageous, as it provides an ‘overhang’ shielding the apertures from sedimentation, reducing the likelihood of sediment falling into the apertures.

Each of the plurality of apertures 254 may have a diameter of at least 1 mm. Such an aperture size may provide apertures large enough to have a tolerably low blockage risk.

Each of the plurality of apertures 254 may have a diameter of less than or equal to 2 mm. Such an aperture size may be small enough to promote sufficient jet velocity for dispersing sediment.

Such an aperture size presents a good compromise between being small enough to provide a sufficient jet velocity for dispersing sediment and large enough to have a tolerably low blockage risk.

The fluid ports 252 may have a constant cross section. The cross-section and/or diameter may also vary within the fluid ports. For example, the plurality of ports 252 may be tapered outwards towards the aperture. Advantageously, tapered fluid ports may ease the clearing of sediment blockages.

The plurality of fluid ports 252 may comprise at 3 to 10 fluid ports 252, and preferably no more than 7 fluid ports 252.

By providing at least 3 fluid ports 252 a wide area around the mixing arrangement can be mixed. By providing no more than 7 fluid ports 252, a convenient minimum flow rate through each port can be maintained, thereby reducing the risk of blockage if a large number of ports is used.

The plurality of apertures 254 may be separated by a vertical tank bottom to aperture distance of at least 3 mm. That is, a central axis of the ports (or apertures) may be at least 3 mm from the tank bottom.

It will be appreciated that the above-described mixing arrangements are not limited to use in any one type of ink tank, such as, for example the ink tanks 200 and 200′ described with respect to FIGS. 3 and 4 respectively. Indeed, any of the above described mixing arrangements could be provided with an ink tank of, by way of example, conical or cylindrical geometry, or tanks having flat or gradually sloping floors.

By way of example, the ink tank 200 of FIG. 3, may be connected to the fluid circuit by means of ports, valves, or connections disposed in the ink tank 200.

As described above, in normal printing operation appropriately mixed ink is continuously drawn into the printhead from the ink storage tank. This may be achieved by a port in the tank allowing fluid communication with the printhead. As described above, a proportion of the ink ejected from the printhead nozzle is returned to the printer via a gutter under suction. Thus, in operation there is a fluid loop comprising the ink tank, the printhead and one or more pumps (e.g. the pump 121 and Venturi 173) driving flow. This gutter flow is returned to the ink storage tank via a port in the tank. There may also be one or more ports for replenishing the level of ink and/or solvent in the ink tank, if low.

In order to effect printer shutdown, the equipment in the printer may be emptied such that the residual ink is substantially drained into the ink tank. By concentrating the fluid into the tank, only one remixing solution is required for the whole system on resumption of inkjet operation. The emptying of the ink held outside the ink tank into the ink tank may be effected by running a fluid supply system ink pump in a reverse direction. By way of example, in FIG. 2 running the pump 119 in reverse, with the 3:2 valve 122 configured to connect the pump outlet to the filter 126, would draw ink from the rest of the system into the ink tank.

During printer shutdown, the above-described ports cease to facilitate fluid flow as the printhead—ink tank fluid loop ceases flow.

On resumption of inkjet operation (e.g. during a start-up operation or sequence), the tank contents are agitated by flow through the mixing arrangement, as described above in relation to FIGS. 3-7. The tank contents may also be agitated by flow through the mixing arrangement during a period of idle operation (i.e. when no printing is taking place).

Therefore, the ink tank may be provided with ports for provide (printhead) ink pickup, gutter return, mixing pickup in addition to a vent and mixing arrangement ports. A number of porting schemes are possible.

For the purposes of the following discussion the mixing arrangement ports will be treated as one port.

In an example, the ink tank may have three ports. The ports may comprise a combined mixing arrangement and ink pickup port, a gutter return port, and a vent. During operation, the ink for the printhead is drawn in or picked-up via the mixing arrangement. The pickup flow is driven by a pump (e.g. pump 121). During resumption of inkjet operation after a period of extended inactivity, the mixing arrangement flow would initially be residual fluid in the mixing arrangement, driven by the pickup pump in reverse flow. A suitably connected ink return line, provided below the ink surface within the tank 117, (e.g. within the bulk region), may be used to supply ink to the mixing arrangement 204 for mixing. Such an arrangement may allow an ink mixing operation to be performed even where the mixing region and/or transition region contain sediment, since the mixing pickup (in this case the ink return line) can pickup ink from bulk region of the ink tank for mixing.

In another example the ink tank may have four ports. The additional port may be added relative to the above-described arrangement by adding a distinct mixing pickup port to supply agitation fluid for use during mixing. That is, a separate mixing pick-up port may be provided for use during reverse operation.

In a further alternative example, the ink tank may also have five ports. The ports may comprise a dedicated mixing arrangement (as described in detail above), a separate main ink pickup port (for providing ink to the printhead), a separate mixing pickup port (for providing ink to the mixing arrangement during mixing), a gutter return port and a vent.

In either of the four or five port arrangements, the mixing pick-up port (e.g. mixing pickup 120, FIG. 2) may be provided in the tank within the bulk region, i.e. above the mixing and (where present) transition regions. Such an arrangement may allow an ink mixing operation to be performed even where the mixing region and/or transition region contain sediment, since the mixing pickup can pickup ink from bulk region of the ink tank for mixing. That is, the ink pump can pump ink from the ink tank via the mixing pickup and supply the pumped ink to the mixing arrangement to mix the ink.

The above-described five-port arrangement may be helpful in cases where the pump is precluded from running in a reverse direction. Potentially this may allow the use of cheaper unidirectional pumps. The five-port arrangement may also be applicable for ink supply systems having two ink pumps. For example, an ink supply system may have one low pressure, high flow and one high pressure, low flow pump.

In practice, the gutter return will contain a multiphase air-fluid flow. Therefore, it may be advantageous to provide the tank with weir plates above the maximum fluid fill level. In use, gutter return flow can run over the weir plates advantageously enhancing bubble removal from the flow. This arrangement entails some degree of increased complexity relative to, for the sake of example, a gutter return port provided below the fluid level.

Of course, various other port arrangements may be possible. Indeed, the ink flow circuit described above with reference to FIG. 2 is provided as an example, and may be modified in various ways. The ink tank 117 of FIG. 2 has a porting arrangement broadly mapping onto the four-port arrangement described above having: (i) a mixing arrangement and ink pickup port, (ii) a mixing pickup port, (iii) a gutter return port, and (iv) a vent. In addition, there are ports fulfilling roles unconsidered in the three-/four-/five-port scheme. Ink tank 117 has a port connecting to purge line 158 and a port 144 admitting ink and solvent from their respective cartridges, labelled 133 and 137.

Various modifications and alternatives may be provided to the above described embodiments. For example, whereas the ink tanks described above are described in the context of a continuous inkjet printer, they may be provided separately. Such ink tanks may be provided as a removable module of an inkjet printer. Similarly, ink tanks having a mixing region may be provided without a mixing arrangement of the sort described, and mixing arrangements of the sort described herein may be provided in ink tanks not having a dedicated mixing region.

The above described embodiments are intended to be illustrative in nature and are not intended to limit or define the scope of protection. The scope of protection is defined by the claims.

In addition to or as an alternative to the above, the following examples are described. The features described in any of the following examples may be utilized with any of the other examples described herein.

Example 1. An ink tank for an inkjet printer comprising a tank floor defining a bottom surface of the tank and tank walls defining sides of the tank during normal use, the tank comprising: a tank bottom defining a lowest point within the tank; a bulk region configured to store a majority of the ink within the ink tank, the tank floor within the bulk region being horizontal or sloping towards the tank bottom during normal use; and a mixing region between the tank bottom and the bulk region partially enclosed by a mixing region tank wall.

Example 2. The ink storage tank according to example 1, further comprising a mixing arrangement provided within the mixing region; wherein the mixing arrangement comprises a plurality of fluid ports each of the plurality of fluid ports comprising a respective aperture, the plurality of fluid ports being configured to direct fluid away from the mixing arrangement and into the mixing region, towards the tank wall surrounding the mixing region and/or towards the tank bottom.

Example 3. The ink storage tank according to example 1 or 2, wherein the tank walls surrounding the mixing region between the tank bottom and the bulk region are vertical or have a steeper gradient than the tank floor in the bulk region.

Example 4. The ink tank according to any one of examples 1 to 3, wherein a gradient of the floor within the bulk region is at least 2 degrees from a nominal horizontal baseline.

Example 5. The ink tank according to any preceding example, wherein the gradient of the tank walls within the mixing region is no greater than 85 degrees from a nominal horizontal baseline.

Example 6. The ink tank according to any one of examples 1 to 5, wherein the tank comprises a vertical depth of at least 15 mm from the tank bottom to a lowest part of the bulk region.

Example 7. The ink tank according to any one of examples 1 to 6, wherein: the ink tank comprises a horizontal width of at least 18 mm at a vertical distance of 10 mm from the tank bottom; and/or the ink tank comprises a horizontal width of no greater than 40 mm at a vertical distance of 10 mm from the tank bottom.

Example 8. The ink tank according to any preceding example, wherein the mixing region has a volume of less than 5% of the total liquid volume of the tank.

Example 9. The ink tank according to any preceding example, further comprising a transition region between the bulk region and the mixing region, wherein: the transition region has a gradient greater than the bulk region floor gradient; and the transition region has a gradient less than the mixing region wall gradient.

Example 10. The ink tank according to example 9, wherein the transition region comprises a vertical depth of at least 15 mm from a highest part of the mixing region to a lowest point of the bulk region.

Example 11. The ink tank according to example 9 or 10, wherein the transition region has a volume of at least 5% of the total liquid volume of the tank.

Example 12. The ink tank according to any preceding example, further comprising a header region, wherein the header region is provided above the bulk region of the tank, is separated from tank floor by at least the bulk region, and extends from a maximum liquid fill level of the tank to a tank roof.

Example 13. The ink tank according to any preceding example, further comprising a level sensor comprising a float and a float chamber, wherein: the float chamber is in fluid connection with the mixing tank at least via an upper connection and a lower connection, the upper connection is provided at or above a maximum liquid fill level of the tank, and the lower connection is at or above an upper limit of the mixing region.

Example 14. The ink tank according to example 13 and example 8, wherein the lower connection is provided within the transition region.

Example 15. The ink tank according to example 13 or 14, wherein: the level sensor is configured to generate a low level signal when the liquid level in the tank is below a minimum fill level; and/or the level sensor is configured to generate a high level signal when the liquid level in the tank is above a liquid maximum fill level.

Example 16. The tank according to any preceding example, further comprising a fluid supply conduit configured to provide fluid to the plurality of fluid ports, the fluid supply conduit being configured to deliver fluid to the mixing arrangement from above the mixing arrangement.

Example 17. The tank according to example 16, wherein the fluid supply conduit comprises a vertical portion directly above the mixing arrangement and a lateral portion configured to deliver fluid to the vertical portion, wherein the lateral portion is sloped upwards away from the junction between the vertical portion and the lateral portion.

Example 18. The tank according to example 16, wherein the fluid supply conduit above the mixing arrangement comprises a vertical straight pipe.

Example 19. The tank according to example 16, wherein the fluid supply conduit above the mixing arrangement comprises a helically coiled pipe.

Example 20. The ink tank according to any one of examples 1 to 15, further comprising a fluid supply conduit configured to provide fluid to the plurality of fluid ports of the mixing arrangement, the fluid supply conduit being configured to deliver fluid to the mixing arrangement from below the mixing arrangement.

Example 21. An ink tank for an inkjet printer comprising a tank floor defining a bottom surface of the tank and tank walls defining sides of the tank during normal use, the tank comprising: a tank bottom defining a lowest point within the tank; a mixing arrangement provided proximate to the tank bottom, the mixing arrangement comprising a plurality of fluid ports each of the plurality of fluid ports comprising a respective aperture, the plurality of fluid ports being configured to direct fluid away from the mixing arrangement and into the region of the tank surrounding the mixing arrangement; and a fluid supply conduit configured to provide fluid to the plurality of fluid ports of the mixing arrangement, the fluid supply conduit being configured to deliver fluid to the mixing arrangement from below the mixing arrangement.

Example 22. The tank according to example 20 or 21, wherein the fluid supply conduit comprises a vertical portion configured to deliver fluid to the mixing arrangement from below the mixing arrangement and a lateral portion configured to deliver fluid to the vertical portion, wherein the lateral portion is sloped upwards away from the junction between the vertical portion and the lateral portion.

Example 23. The tank according to example 22, wherein the fluid supply conduit further comprises a sump tank at the junction between the vertical portion and the lateral portion, the sump tank being configured to receive sediment from the lateral portion.

Example 24. The tank according to any preceding example, wherein the plurality of fluid ports is configured to direct fluid from the mixing arrangement in a plurality of directions and wherein: each of the plurality of directions comprises a horizontal component and a vertically downwards component; and/or at least one of the plurality of directions comprises a non-radial horizontal component.

Example 25. The tank according to any preceding example, wherein the plurality of fluid ports is configured to direct fluid towards a perimeter of the tank bottom.

Example 26. The tank according to any preceding example, wherein: each of the plurality of apertures is oriented vertically, or at least partially downwards; and/or each of the plurality of apertures has a diameter of at least 1 mm; and/or each of the plurality of apertures has a diameter of less than or equal to 2 mm.

Example 27. The tank according to any preceding example, wherein: the plurality of fluid ports comprises at least 3 fluid ports; and/or the plurality of fluid ports comprises no more than 10 fluid ports, preferably no more than 7 fluid ports.

Example 28. The tank according to any preceding example, wherein central axes of the plurality of fluid ports are provided at a vertical separation distance of at least 3 mm from the tank bottom.

Example 29. The tank according to any preceding example, wherein each of the plurality of apertures is provided at a horizontal separation distance of no greater than 15 mm from the tank wall.

Example 30. The tank according to any preceding example, further comprising a mixing pickup configured to pickup ink fluid from the ink tank for mixing the ink, wherein the mixing pickup is provided within the bulk region.

Example 31. An ink system comprising: an ink tank according to any one of examples 1 to 30; and a mixing arrangement configured to mix ink within the mixing region.

Example 32. An ink system comprising: an ink tank according to any one of examples 1 to 30; and a pump configured to supply fluid to the mixing region.

Example 33. An ink system comprising: an ink tank according to any one of examples 1 to 30; and a pump configured to supply fluid to the mixing arrangement to mix ink.

Example 34. The ink system according to any one of examples 31 to 33; wherein the pump is configured to pump ink from the ink tank via the mixing pickup and to supply the pumped ink to the mixing arrangement to mix ink.

Example 35. The ink system according to any one of examples 31 to 34, wherein: the ink system is configured to drain ink into the ink tank during a shutdown operation; and the ink system is configured to mix ink within the ink tank during a start-up operation, or during a period of idle operation.

Example 36. A continuous inkjet printer comprising the ink system of any one of examples 31 to 35, further comprising: a droplet generator configured to receive ink from the ink system and to produce a jet of ink for printing; a gutter configured to receive parts of the jet that are not required for printing; a gutter line connected to the gutter and configured to return unprinted ink to the ink tank.

Example 37. The continuous inkjet printer according to example 36, further comprising a printhead operable to receive ink from the ink system for printing, wherein the printhead comprises the droplet generator and the gutter.

Example 38. The continuous inkjet printer according to any one of examples 36 or 37, wherein the continuous inkjet printer is an electrostatic deflection continuous inkjet printer configured to selectively charge ink droplets within the ink jet and to deflect charged droplets in an electrostatic field.

Example 39. A method of mixing pigmented ink comprising; storing ink in an ink tank, the ink tank comprising a tank floor defining a bottom surface of the tank and tank walls defining sides of the tank during normal use, wherein the tank comprises: a tank bottom defining a lowest point within the tank; a bulk region configured to store a majority of the ink within the ink tank, the tank floor within the bulk region being horizontal or sloping towards the tank bottom; and a mixing region between the tank bottom and the bulk region partially enclosed by a mixing region tank wall; the method further comprising mixing the ink within the mixing region.

Example 40. The method according to example 39, wherein the tank comprises a mixing arrangement provided within the mixing region, the method further comprising: supplying fluid to the mixing arrangement; and directing fluid away from the mixing arrangement and into the mixing region towards the mixing region tank wall and/or towards the tank bottom from a plurality of fluid ports to mix the ink, each of the plurality of fluid ports comprising a respective aperture.

Example 41. A method of mixing pigmented ink comprising; storing ink in an ink tank, the ink tank comprising a tank floor defining a bottom surface of the tank and tank walls defining sides of the tank during normal use, wherein the tank comprises a tank bottom defining a lowest point within the tank and a mixing arrangement provided proximate to the tank bottom; supplying, to the mixing arrangement via a fluid supply conduit, fluid from below the mixing arrangement; and directing fluid away from the mixing arrangement and into the region of the tank surrounding the mixing arrangement from a plurality of fluid ports to mix the ink.

1. An ink tank for an inkjet printer comprising:
a tank floor defining a bottom surface of the ink tank and tank walls defining sides of the ink tank during normal use;
a tank bottom defining a lowest point within the ink tank;
a bulk region configured to store a majority of ink within the ink tank, the tank floor within the bulk region being horizontal or sloping towards the tank bottom during normal use;
a mixing region between the tank bottom and the bulk region partially enclosed by a mixing region tank wall; and
a mixing arrangement provided within the mixing region;
wherein the mixing arrangement comprises a plurality of fluid ports each of the plurality of fluid ports comprising a respective aperture, the plurality of fluid ports being configured to direct fluid away from the mixing arrangement and into the mixing region, towards the tank walls surrounding the mixing region and/or towards the tank bottom.

2. The ink tank according to claim 1, wherein the tank walls surrounding the mixing region between the tank bottom and the bulk region are vertical or have a steeper gradient than the tank floor in the bulk region.

3. The ink tank according to claim 1, wherein a gradient of the tank floor within the bulk region is at least 2 degrees from a nominal horizontal baseline.

4. The ink tank according to claim 1, wherein the mixing region has a volume of less than 5% of a total liquid volume of the tank.

5. The ink tank according to claim 1, further comprising a transition region between the bulk region and the mixing region, wherein:
the transition region has a gradient greater than a bulk region floor gradient; and
the transition region has a gradient less than a mixing region wall gradient.

6. (canceled)

7. The ink tank according to claim 1, further comprising a header region, wherein the header region is provided above the bulk region of the tank, is separated from tank floor by at least the bulk region, and extends from a maximum liquid fill level of the tank to a tank roof.

8. The ink tank according to claim 1, further comprising a level sensor comprising a float and a float chamber, wherein:
the float chamber is in fluid connection with the ink tank at least via an upper connection and a lower connection,
the upper connection is provided at or above a maximum liquid fill level of the tank, and
the lower connection is at or above an upper limit of the mixing region.

9. The ink tank according to claim 1, further comprising a fluid supply conduit configured to provide fluid to the plurality of fluid ports, the fluid supply conduit being configured to deliver fluid to the mixing arrangement from above the mixing arrangement.

10. The ink tank according to claim 9, wherein:
the fluid supply conduit comprises a vertical portion directly above the mixing arrangement and a lateral portion configured to deliver fluid to the vertical portion, wherein the lateral portion is sloped upwards away from a junction between the vertical portion and the lateral portion; or
the fluid supply conduit above the mixing arrangement comprises a vertical straight pipe; or
the fluid supply conduit above the mixing arrangement comprises a helically coiled pipe.

11. The ink tank according to claim 1, further comprising a fluid supply conduit configured to provide fluid to the plurality of fluid ports of the mixing arrangement, the fluid supply conduit being configured to deliver fluid to the mixing arrangement from below the mixing arrangement.

12. (canceled)

13. The ink tank according to claim 11,
wherein the fluid supply conduit comprises a vertical portion configured to deliver fluid to the mixing arrangement from below the mixing arrangement and a lateral portion configured to deliver fluid to the vertical portion, wherein the lateral portion is sloped upwards away from a junction between the vertical portion and the lateral portion, and
wherein the fluid supply conduit further comprises a sump tank at the junction between the vertical portion and the lateral portion, the sump tank being configured to receive sediment from the lateral portion.

14. The ink tank according to claim 13,
wherein the plurality of fluid ports is configured to direct fluid from the mixing arrangement in a plurality of directions and
wherein:
each of the plurality of directions comprises a horizontal component and a vertically downwards component; and/or
at least one of the plurality of directions comprises a non-radial horizontal component.

15. The ink tank according to claim 13, wherein the plurality of fluid ports is configured to direct fluid towards a perimeter of the tank bottom.

16. The ink tank according to claim 13, wherein:
each of the plurality of apertures is oriented vertically, or at least partially downwards; and/or
each of the plurality of apertures has a diameter of at least 1 mm; and/or
each of the plurality of apertures has a diameter of less than or equal to 2 mm.

17. The ink tank according to claim 13, wherein
the plurality of fluid ports comprises at least 3 fluid ports; and/or
the plurality of fluid ports comprises no more than 10 fluid ports, preferably no more than 7 fluid ports; and/or
central axes of the plurality of fluid ports are provided at a vertical separation distance of at least 3 mm from the tank bottom; and/or
each of the plurality of apertures is provided at a horizontal separation distance of no greater than 15 mm from the tank walls.

18. The ink tank according to claim 13, further comprising a mixing pickup configured to pickup ink fluid from the ink tank for mixing the ink, wherein the mixing pickup is provided within the bulk region.

19-21. (canceled)

22. A continuous inkjet printer comprising:
an ink system comprising,
an ink tank comprising a tank floor defining a bottom surface of the ink tank and tank walls defining sides of the ink tank during normal use, the ink tank comprising,
a tank bottom defining a lowest point within the ink tank;
a bulk region configured to store a majority of the ink within the ink tank, the tank floor within the bulk region being horizontal or sloping towards the tank bottom during normal use;
a mixing region between the tank bottom and the bulk region partially enclosed by a mixing region tank wall; and
a mixing arrangement provided within the mixing region;
wherein the mixing arrangement comprises a plurality of fluid ports each of the plurality of fluid ports comprising a respective aperture, the plurality of fluid ports being configured to direct fluid away from the mixing arrangement and into the mixing region, towards the tank walls surrounding the mixing region and/or towards the tank bottom; and
a pump is configured to pump ink from the ink tank via the mixing pickup and to supply the pumped ink to the mixing arrangement to mix ink;
a droplet generator configured to receive ink from the ink system and to produce a jet of ink for printing;
a gutter configured to receive parts of the jet that are not required for printing; and
a gutter line connected to the gutter and configured to return unprinted ink to the ink tank.

23. The continuous inkjet printer according to claim 22, further comprising a printhead operable to receive ink from the ink system for printing, wherein the printhead comprises the droplet generator and the gutter.

24. The continuous inkjet printer according to claim 22, wherein the continuous inkjet printer is an electrostatic deflection continuous inkjet printer configured to selectively charge ink droplets within the ink jet and to deflect charged droplets in an electrostatic field.

25. A method of mixing pigmented ink comprising:
storing ink in an ink tank, the ink tank comprising a tank floor defining a bottom surface of the ink tank and tank walls defining sides of the ink tank during normal use, wherein the ink tank comprises,
a tank bottom defining a lowest point within the ink tank;
a bulk region configured to store a majority of the ink within the ink tank, the tank floor within the bulk region being horizontal or sloping towards the tank bottom; and
a mixing region between the tank bottom and the bulk region partially enclosed by a mixing region tank wall; and
a mixing arrangement provided within the mixing region;
supplying fluid to the mixing arrangement; and
directing fluid away from the mixing arrangement and into the mixing region towards the mixing region tank wall and/or towards the tank bottom from a plurality of fluid ports to mix the ink, each of the plurality of fluid ports comprising a respective aperture.

26. (canceled)
